(19) United States
(12) Patent Application Publication
(10) Pub. No.: US 2025/0390009 A1
(43) Pub. Date: Dec. 25, 2025

(54) 360 DEGREE VIEW CAMERA ASSEMBLY

(71) Applicant: Circa Resorts LLC, Las Vegas, NV (US)

(72) Inventor: Greg STEVENS, Las Vegas, NV (US)

(21) Appl. No.: 19/245,807

(22) Filed: Jun. 23, 2025

Related U.S. Application Data
(60) Provisional application No. 63/662,758, filed on Jun. 21, 2024.

(51) Int. Cl. G03B 17/56; G03B 37/04

(52) U.S. Cl. CPC G03B 17/561; G03B 37/04

(57) ABSTRACT

A camera assembly for being positioned along a pole includes a camera housing that extends annularly about an axis. A plurality of cameras are connected to the camera housing in circumferentially spaced relationship with one another about the axis and pointed radially outwardly relative to the axis for providing a 360 degree view around the camera assembly. The camera housing defines at least one opening along the axis for receiving the pole to connect the camera assembly to the pole.

### CROSS-REFERENCE TO RELATED APPLICATIONS

This utility patent application claims priority to U.S. Provisional Patent Application Ser. No. 63/662,758, filed on Jun. 21, 2024, and titled “360 Degree View Camera Assembly,” the entire disclosure of which is hereby incorporated by reference in its entirety.

### BACKGROUND OF THE DISCLOSURE

### 1. Field of the Disclosure

The present disclosure relates to camera assemblies, such as security camera assemblies.

### 2. Related Art

This section provides background information related to the present disclosure which is not necessarily prior art.

Security cameras have long been known in the art and have undergone significant advancements over the years, evolving from simple, stationary devices to sophisticated systems. The introduction of digital cameras marked a pivotal shift in the security camera industry, enhancing image quality, reducing costs, allowing cameras to be positioned at new locations using wireless connectivity, and allowing for remote monitoring and control through mobile applications. There remains a need for further developments to security cameras.

### SUMMARY OF THE DISCLOSURE

According to an aspect of the disclosure, a camera assembly for being positioned along a pole includes a camera housing that extends annularly about an axis. A plurality of cameras are connected to the camera housing in circumferentially spaced relationship with one another about the axis and pointed radially outwardly relative to the axis for providing a 360 degree view around the camera assembly. The camera housing defines at least one opening along the axis for receiving the pole to connect the camera assembly to the pole.

According to another aspect of the disclosure, a camera assembly for being positioned along a pole includes a camera housing that extends annularly about an axis. A plurality of cameras are connected to the camera housing in circumferentially spaced relationship with one another about the axis and pointed radially outwardly relative to the axis for providing a 360 degree view around the camera assembly. The camera housing is comprised of a first segment and a second segment. The first and second segments are connectable to one another about the pole to connect the camera housing to the pole. The first and second segments each terminate at an end. The ends of the first segment are along a first plane. The ends of the second segment are along a second plane. The first and second segments are connected to one another. The ends of the first segments are generally flush with the ends of the second segment.

According to another aspect of the disclosure, a security camera for being positioned along a pole includes a camera housing. A plurality of cameras are positioned in the housing in circumferentially spaced relationship with one another about an axis and pointed radially outwardly relative to the axis for providing a 360 degree view around the camera assembly. A lower sleeve extends downwardly from the camera housing. The lower sleeve is configured to be connected to a lower segment of the pole to connect the camera housing to the lower segment of the pole. An upper sleeve extends upwardly from the camera housing. The upper sleeve is configured to be connected to an upper segment of the pole to connect the camera housing to the upper segment of the pole.

The subject security camera assembly can easily be connected to poles, e.g., light poles and signs, in order to provide a 360 degree camera view around the pole. The embodiments of the camera assembly are also simple in design and inexpensive to manufacture.

### BRIEF DESCRIPTION OF THE DRAWINGS

These and other aspects of the present disclosure will be more readily understood by reference to the following description in combination with the accompanying drawings wherein:

FIG. 1A is a perspective view of a first embodiment of a camera assembly according to an aspect of the disclosure, illustrating the camera assembly connected to a pole of a light assembly;

FIG. 1B is a magnified perspective view of the first embodiment of the camera assembly;

FIG. 1C is a top, schematic view of the first embodiment of the camera assembly, illustrating a first arrangement of a connecting mechanism;

FIG. 1D is a top, schematic view of the first embodiment of the camera assembly, illustrating a second arrangement of a connecting mechanism;

FIG. 2A is a perspective view of a second embodiment of a camera assembly, illustrating the camera assembly mounted to a pole of a light assembly; and

FIG. 2B is a magnified perspective view of the second embodiment of the camera assembly.

### DETAILED DESCRIPTION OF THE ENABLING EMBODIMENTS

Example embodiments will now be described more fully with reference to the accompanying drawings. In general, the subject embodiments are directed to a security camera assembly. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Referring to the figures, wherein like numerals indicate corresponding parts throughout the several views, embodiments of a security camera assembly 20, 120 are provided. The security camera assembly 20, 120 includes an arrangement of cameras 22, 122 that are configured to be positioned 360 degrees around a center axis A along a pole 24, 124 to permit the cameras 22, 122 to record footage 360 degrees around the pole 24, 124. The embodiments of the security camera assembly 20, 120 may be connected to the pole 24, 124 in a simple and efficient manner. The security camera assembly 10, 120 may be connected to various types of poles 24, 124, such as light poles or signs. Any number of cameras 22, 122 may be used and they may be spaced from each other at various distances. Various types of cameras 22, 122 may be used, such as digital and film cameras. The cameras 22, 122 may be configured to record still images as well as video footage.

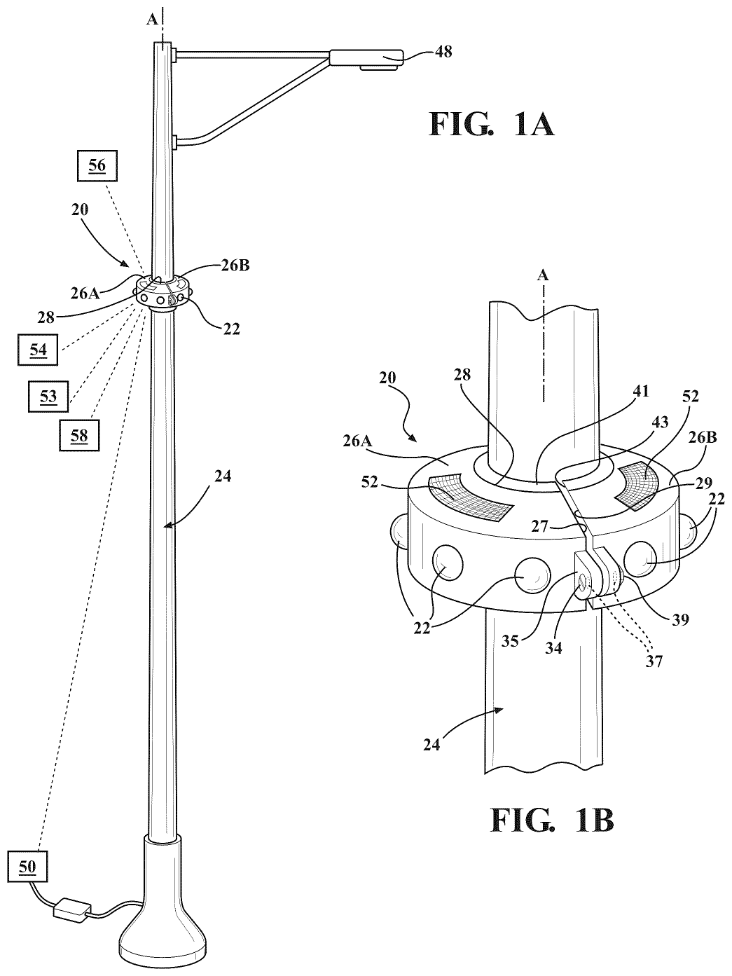

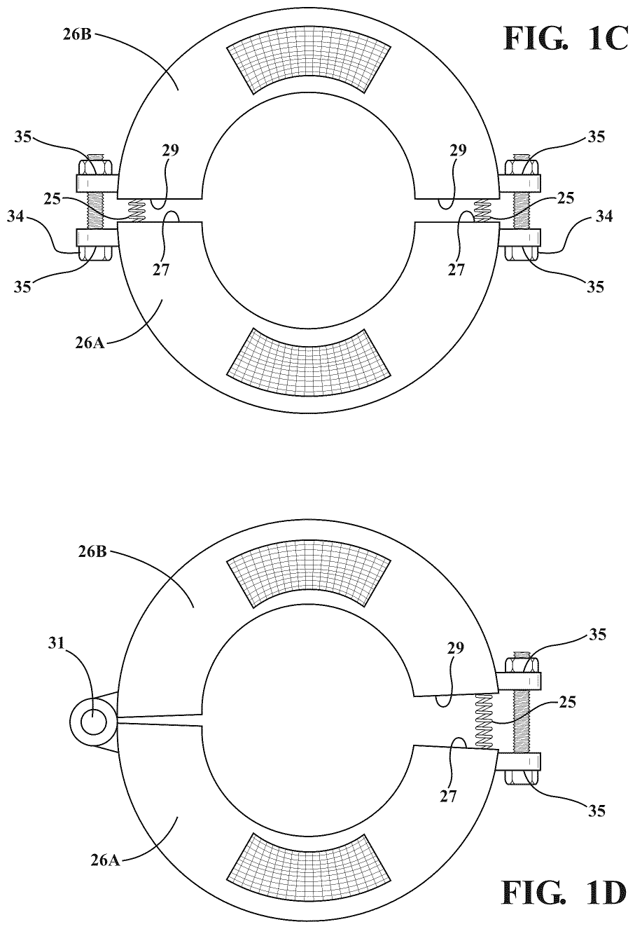

With reference to FIGS. 1A-1C, a first embodiment of the security camera assembly 20 is a two-piece assembly which may easily be positioned about, and connected to a single-piece pole 24. The assembly 20 includes a generally disc-shaped camera housing 26A, 26B. The camera housing 26A, 26B holds a plurality of the cameras 22, e.g., six, in circumferentially spaced relationship with one another and pointed radially outwardly from the axis A for providing a 360 degree view around the camera assembly 20. The camera housing 26A, 26B defines an opening 28 along the center axis A for receiving the pole 24, with an inside surface of the camera housing 26 in the opening 28 engaging the pole 24. Once the camera assembly 26 is connected, the center axis A extends along a longitudinal length of the pole 24.

The camera housing 26A, 26B may be separated into a first segment 26A and a second segment 26B that are detachably connectable to one another and configured to be compressed toward one another against the pole 24 to secure the camera housing 26A, 26B to the pole 24. The first segment 26A terminates at a pair of first ends 27, and the second segment 26B terminates at a pair of second ends 29. According to the shown embodiment, the first ends 27 extend along a first plane and the second ends 29 extend along a second plane, and when the first and second segments 26A, 26B are connected to one another, the ends 27, 29 of the first and second segments 26A, 26B lie flush over one another substantially along a common plane. A connecting mechanism 33A, 33B is configured to detachably connect the first and second segments 30, 32 of the camera housing 26 to the pole 24 and to tighten the first and second segments 26A, 26B against the pole 24 to fix the camera assembly 20 in place.

As best shown in FIGS. 1B and 1C, a first arrangement of the connecting mechanism 33A includes two or more flanges 35 that each extend outwardly from one of the segments 26A, 26B of the housing 26A, 26B and are configured to be aligned with one another when the segments 26A, 26B are positioned about the pole 24. The flanges 35 may define orifices 37 to receive the bolts 34. A nut 39 may be threaded to an end of the bolt 34 to secure the bolt in place. As shown in FIG. 1C, the connecting mechanism 33A may include an arrangement of two flanges 35 and one bolt 34 on opposing circumferential sides of the housing 26A, 26B.

As shown in FIG. 1D, according to another arrangement of the connecting mechanism, 33B, the segments 26A, 26B of the housing 26A, 26B may be pivotally connected to each other at a pivoting mechanism 31 along one side of the housing 26A, 26B, and an arrangement of flanges 35 and a bolt 34 may be located on an opposite side to permit the housing 26A, 26B to be pivotally opened to clamp around the pole 24. Other types of connecting mechanisms may be utilized such as latches, hook and loop connectors, etc. Furthermore, a biasing mechanism 25, like a spring, may bias the segments toward one another 26A, 26B against the pole 24.

The assembly 20 may be connected to poles 24 of various sizes, e.g., a 6 or 8 inch diameter. A bushing 41 may be positioned along the opening 28 to allow the assembly 20A to be coupled with more narrow poles 24. The bushing 41 may have various thicknesses to accommodate poles 24 of different sizes. The bushing 41 may have a slot 43 to allow the bushing to be elastically opened and positioned about the pole 24.

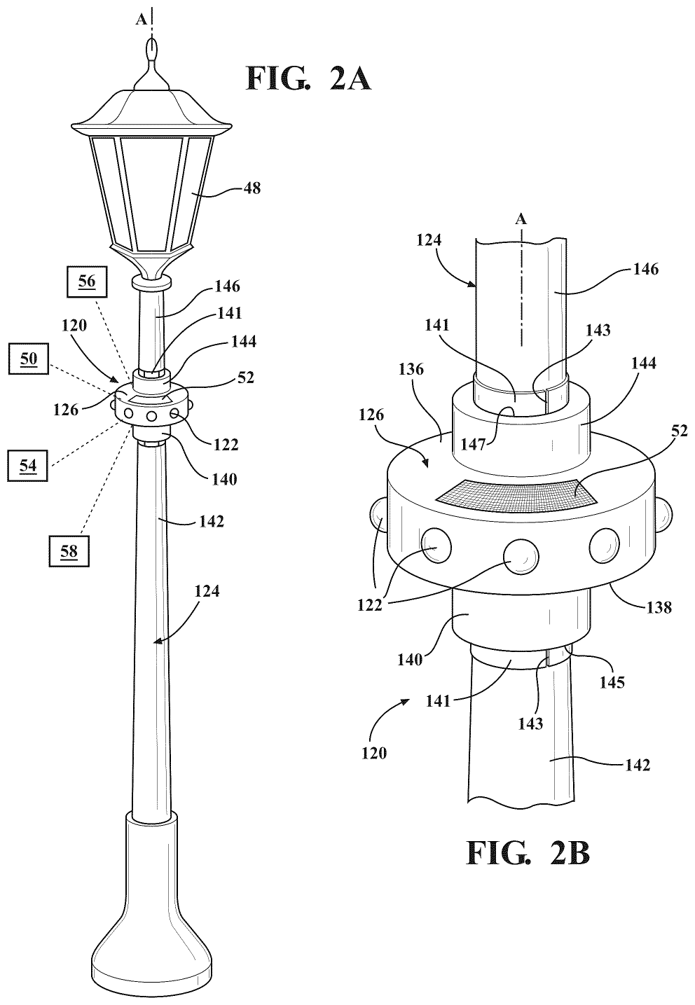

A second embodiment of the security camera assembly 120 is shown in FIG. 2A-2B. This embodiment is configured as a one-piece assembly, which requires no assembly of components of the camera assembly 120 relative to one another. The camera assembly 120 has a camera housing 126 which holds a plurality of cameras 122 positioned in circumferentially spaced relationship with one another and pointed radially outwardly from the axis A for providing a 360 degree view around the camera assembly 120. The camera housing 126 has an upper surface 136 and a lower surface 138.

A lower sleeve 140 is connected to the lower surface 138 of the camera housing 126 and extends downwardly from the camera housing 126 along the center axis A. The lower sleeve 140 is configured to receive top of a lower segment 142 of the pole 124 in a lower opening 145 of the sleeve 140 to connect the camera housing 126 to the lower segment 142 of the pole 124. Alternatively, the lower sleeve 140 may be received in an opening of the lower segment 142 of the pole 124. An upper sleeve 144 is connected to the upper surface 136 of the camera housing 126 and extends upwardly from the camera housing 126. The upper sleeve 144 is configured to receive an upper segment 146 of the pole 124 in an upper opening 147 to connect the camera housing 126 to the upper segment 146. Alternatively, the upper sleeve 144 may be received in an opening of the upper segment 146 of the pole 124. Accordingly, the camera housing 126 is sandwiched between the lower and upper segments 142, 146 of the pole 124. As an alternative, the upper and lower sleeves 140, 144 may be a single, one-piece component that extends through the camera housing 126. Wires associated with features of the pole 24, like a light assembly, may pass through the camera assembly 20.

A bushing 141 may be positioned in one or more of the upper and lower sleeves 140, 144 to allow the assembly 120 to be coupled with more narrow poles 124. Again, the bushing 141 may have various thicknesses to accommodate poles 124 of different sizes. The bushing 141 may have a slot 143 to allow the bushing 141 to be elastically opened and positioned about the pole 124

As schematically shown in FIGS. 1A and 2A, both embodiments of the camera assembly 20, 120 are connected to a power source 50 for powering the cameras 22, 122 of the camera housing 26A, 26B, 126. The power source 50 may include various types of power sources, including batteries or a mains electricity source. The power source 50 may be positioned in a compartment of the camera housing 26A, 26B, 126, such as when the power source 50 is comprised of batteries. One or more solar panels 52 may be positioned on top of the camera housing 26 for charging the power source 50. Alternatively, one or more power lines 54 may electrically connect the cameras 22 to the power source 50, such as when a mains electricity source is used. The power line 54 may extend through the lower pole or along a sidewall of the lower pole inside or independent of a conduit.

The security camera assembly 20A, 20B may also include a controller 53 and wireless communication device 56 for permitting the security camera assembly 20A, 20B to be controlled, and to established wireless communication with other devices, e.g., cloud based networks, mobile devices and personal computers. The wireless connection may permit footage to be viewed and externally saved, and may also permit operators to modify the cameras 22, e.g., change a field of vision, or orient the cameras 22 in desired directions. The controller 53 may also have an internal hard drive 58 for locally saving footage.

As shown, a light assembly 48 may be connected to the upper segment 46 of the pole 24 in the event that the pole 24 is part of a light assembly. Other features may be connected to the upper segment 46 of the pole 24, e.g., a sign.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in any embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A camera assembly for being positioned along a pole, comprising:
a camera housing extending annularly about an axis;
a plurality of cameras connected to the camera housing in circumferentially spaced relationship with one another about the axis and pointed radially outwardly relative to the axis for providing a 360 degree view around the camera assembly; and
the camera housing defining at least one opening along the axis for being receiving to the pole to connect the camera assembly to the pole.

2. The camera assembly as set forth in claim 1, wherein the camera housing is comprised of a first segment and a second segment, and wherein the first and second segments are connectable to one another about the pole to connect the camera housing to the pole.

3. The camera assembly as set forth in claim 1, wherein at least one fastener removeably connects the first and second segments of the camera housing to one another.

4. The camera assembly as set forth in claim 1, wherein the first and second segments each have a pair of ends, and wherein the ends of the first segment are each located proximate one of the ends of the second segment when the first and second segments are connected to one another.

5. The camera assembly as set forth in claim 4, wherein the ends of the first segments each along a first plane, and wherein the ends of the second segment extend along a second plane such that the ends of the first segment are substantially flush with the ends of the second segments when the first and second segments are connected to one another.

6. The camera assembly as set forth in claim 4, wherein a flange is positioned adjacent to at least one of the ends of each of the first and second segments, and wherein a fastener connects the flanges of the first and second segments to one another and to compress the first and second segments against the pole.

7. The camera assembly as set forth in claim 6, wherein a flange is positioned adjacent to each of the ends of the first and second segments, and wherein two fasteners each connect two of the flanges of the first and second segments.

8. The camera assembly as set forth in claim 4, wherein a pivoting mechanism connects one of the ends of the first segments to one of the ends of the second segments to provide pivoting of the first and second segments relative to one another along the pivoting mechanism.

9. The camera assembly as set forth in claim 1, wherein the camera housing has a top surface and a bottom surface, wherein a lower sleeve is connected to the lower surface and extends downwardly from the camera housing along the axis, and wherein the at least one opening includes a lower sleeve opening defined by the lower sleeve for being connected to a bottom segment of the pole.

10. The camera assembly as set forth in claim 9, wherein the at least one opening further includes an upper sleeve opening defined by the upper sleeve for being connected to a top segment of the pole.

11. The camera assembly as set forth in claim 1, wherein a bushing is positioned in the at least one opening to be positioned about the pole to accommodate a difference in a diameter of the pole relative to a diameter of the opening of the camera housing.

12. The camera assembly as set forth in claim 1, further including a power source stored in the camera housing for powering the cameras.

13. The camera assembly as set forth in claim 12, further including at least one solar panel connected to the camera housing and configured to charge the power source.

14. A camera assembly for being positioned along a pole, comprising:
a camera housing extending annularly about an axis;
a plurality of cameras connected to the camera housing in circumferentially spaced relationship with one another about the axis and pointed radially outwardly relative to the axis for providing a 360 degree view around the camera assembly;
the camera housing comprised of a first segment and a second segment, wherein the first and second segments are connectable to one another about the pole to connect the camera housing to the pole; and
the first and second segments each terminating at an end, wherein the ends of the first segment are along a first plane, wherein the ends of the second segment are along a second plane, and wherein when the first and second segments are connected to one another, the ends of the first segments are generally flush with the ends of the second segment.

15. A security camera for being positioned along a pole, comprising:
a camera housing;
a plurality of cameras positioned in the housing in circumferentially spaced relationship with one another about an axis and pointed radially outwardly relative to the axis for providing a 360 degree view around the camera assembly;
a lower sleeve extending downwardly from the camera housing, the lower sleeve configured to be connected to a lower segment of the pole to connect the camera housing to the lower segment of the pole; and
an upper sleeve extending upwardly from the camera housing, the upper sleeve configured to be connected to an upper segment of the pole to connect the camera housing to the upper segment of the pole.
